(19) United States
(12) Patent Application Publication
(10) Pub. No.: US 2026/0132570 A1
(43) Pub. Date: May 14, 2026

(54) Printing Process For Clothing

(71) Applicant: Zhigang Chen, Nan'an (CN)

(72) Inventor: Zhigang Chen, Nan'an (CN)

(21) Appl. No.: 18/944,479

(22) Filed: Nov. 12, 2024

(51) Int. Cl. D06P 5/24; B41F 16/02; D06P 5/20

(52) U.S. Cl. CPC D06P 5/008; B41F 16/02; D06P 5/2072

(57) ABSTRACT

This invention relates to the field of clothing production technology, specifically referring to printing process for clothing, which includes preparing finished clothing, preparing a cardboard, preparing printing paper, stretching the finished clothing, and transferring the pattern. In the process of producing the finished garments, mass production can be carried out. When stretching the finished garments, the cardboard is embedded into the finished garments to maximize the expansion and flattening of the finished garments, so that the entire front and back of the finished garments remain flat during the subsequent transfer printing process. It only needs to transfer the pattern to the pre-produced finished garments, which can greatly reduce the inventory of clothing for a single style. For individual entrepreneurs, internet celebrities, and authorized parties of intellectual properties, they can cover all patterns and IPs with lower inventory, thus reducing capital occupation, lowering financing costs, and operational risks.

### TECHNICAL FIELD

This invention relates to the field of clothing production technology, specifically referring to printing process for clothing.

### BACKGROUND OF THE PRESENT INVENTION

The digital heat transfer printing process in clothing production has matured and improved, allowing for low-cost and fast customization of large orders. The general production process of this manufacturing technique is as follows: the fabric is stacked by a loosening machine; the stacked fabric is then cut into pieces by cutting equipment; the pattern is heat-transferred onto the pieces by a roller machine to create printed pieces; finally, the printed pieces are sewn together through stitching to obtain garments with the desired patterns. It can be seen that to achieve assembly line operations in this production process, a large quantity of clothing orders is needed to reduce the cost per piece, thus requiring a large amount of stocking.

However, with the increasing personalized demands of consumers, the rapid changes in trendy elements have led to a lot of uncertainty in the sales volume and sales cycle of a piece of clothing. At the same time, considering the current economic downturn, it is evident that blindly stocking up in large quantities may lead to an increase in inventory for businesses, thereby increasing operational risks.

### SUMMARY OF THE PRESENT INVENTION

In response to the shortcomings of the background technology mentioned above, the present invention provides printing process for clothing.

The present invention adopts the following technical solution:
Printing process for clothing, characterized in that the printing process comprises:
   Prepare finished garments, where the finished garments are sewn with black mesh thread at the seam joints to form an overlay area;
   Prepare a cardboard backing that matches the shape of the finished garment and is larger than the size of the garment when laid flat;
   Prepare stamp paper, the area of the pattern on the stamp paper is larger than the area of the cardboard;
   Support the finished garment, insert the cardboard into the finished garment, and use the cardboard to expand the finished garment into a panel structure, which has a front and back with the pattern to be transferred, and fold the edge of the covering area to the side with the pattern to be transferred;
   Transfer the pattern by placing the front and back of the panel structure facing up and covering it with transfer paper. Then press each side separately to transfer the pattern to the front and back of the finished garment, thus completing the garment printing.

As an improvement to the above process, the card board has hook slots on both sides in the embedded part of the garment. After the card board is embedded in the finished garment, the hook slots hook onto the inner side of the finished garment.

As an improvement to the above process, when the finished garment is pants, a black piece is used in the crotch area of the finished garment.

As an improvement to the above process, before transferring the heat transfer pattern, if the finished garment has areas that do not require printing, those areas are covered with high-temperature tape.

As an improvement of the above process, the transfer equipment is a flat heat transfer machine. When transferring the heat transfer pattern, the pressure set on the transfer equipment is 0.6-0.8 MP, the temperature set around is 210-220° C., the temperature set in the middle is 205-215° C., and the pressing time is 65-75 seconds.

As an improvement to the above process, when transferring patterns, a layer of silicone pad is laid on the workbench of the transfer printing equipment, and the panel structure is placed on the silicone pad.

As an improvement to the above process, the printing process also includes preheating with compressed air. After the panel structure is placed on the workbench of the transfer printing equipment, and before the printing paper is covered on the panel structure, the transfer printing equipment presses at a set temperature for 8-12 seconds; Then, the printing paper is covered on the surface of the panel structure for the printing pattern, aligning the pattern of the printing paper with the surface of the panel structure, and then pressing the printing paper and the panel structure to complete the heat transfer of the pattern.

As an improvement of the above process, during the air compression preheating, a layer of protective paper is covered on both the front and back of the panel structure; after the air compression preheating is completed, the protective paper above the panel structure is removed, and the printed paper is then covered on the panel structure.

As an improvement to the above process, the processing steps of the finished garments are as follows: the fabric is cut into pieces, then the pieces are sent to the workshop for sewing, after passing inspection, they are ironed to obtain the finished garments.

From the above description of the present invention, it can be seen that compared with the prior art, the present invention has the following advantages: In the printing process of the present invention, finished garments can be produced in batches, and then relevant patterns can be printed on the finished garments according to demand, thus forming a style of clothing. This process does not require a large amount of inventory for each style, as the pattern can be transferred to pre-produced garments, greatly reducing the inventory of individual clothing styles. For individual entrepreneurs, internet celebrities, and authorized parties of intellectual properties, they can cover all patterns and IPs with lower inventory, thus reducing capital occupation, lowering financing costs, and operational risks.

### BRIEF DESCRIPTION OF THE DRAWINGS

FIG. 1 is a schematic diagram of an embodiment of finished clothing as pants.

FIG. 2 is a schematic diagram of an embodiment of the card board embedded in the pants.

FIG. 3 shows a schematic diagram of the embedded cardboard in the finished garment.

FIG. 4 is a top view of the garment with the printed paper covering it.

FIG. 5 shows a schematic diagram of finished garments placed on the transfer equipment after mounting the cardboard.

### DETAILED DESCRIPTION OF THE EMBODIMENT'S

Specific embodiments of the present invention are described below with reference to the accompanying drawings.

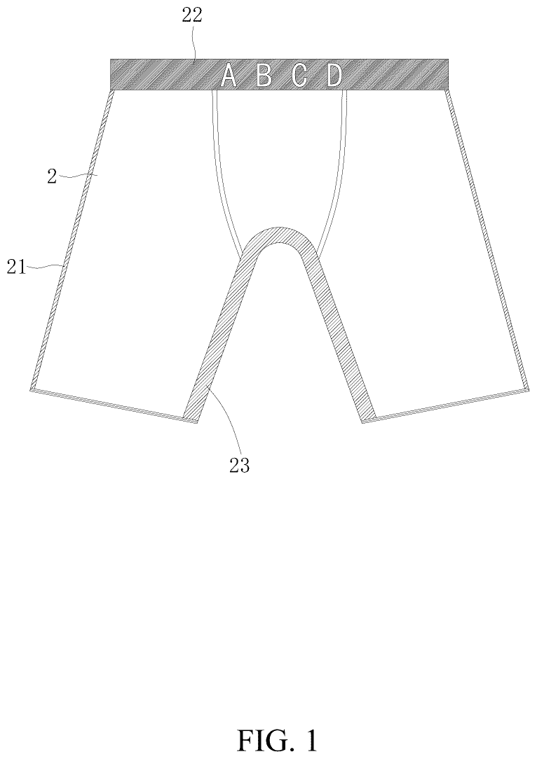

This invention discloses printing process for clothing, which includes preparing finished clothing, preparing cardboard, preparing printing paper, stretching the finished clothing, and heat transferring the pattern. Here are the details:
In the finished garment as prepared, the positions where the cut pieces are sewn together are stitched with black thread, forming an overlay area 21 as shown in, for example, FIG. 1. The processing steps of the finished clothing can be cutting the fabric into pieces, sending the pieces to the workshop for sewing, inspecting and ironing after passing the inspection, and then obtaining the finished clothing. The fabric can be white fabric. Referring to FIG. 1, when the finished garment 2 is a pair of pants, black fabric pieces are used in the crotch area 23 of the finished garment 2. Due to the fact that the crotch area of the pants will still have wrinkles or fabric marks when laid flat, making it impossible to print a complete pattern on it, black fabric can be used to absorb or cover all patterns printed on this area, ensuring that the black crotch is retained after printing to avoid leaving blank or uneven patterns due to wrinkles or marks during transfer.

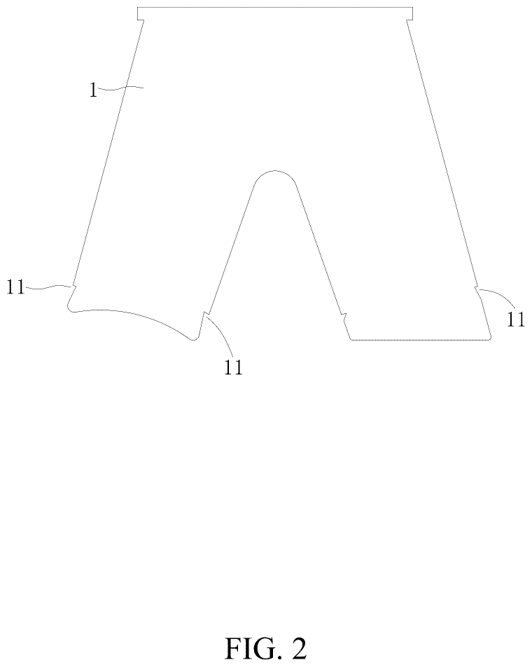

In the prepared card board, the shape matches the finished garment, and the size of the card board is larger than the size of the finished garment after flattening. For example, as shown in FIGS. 1 and 2, when the finished garment 2 is a pair of pants, the cardboard pattern 1 is of the same pants shape. When the finished garment is a top, the cardboard is of the same shape as the top. The processing process of the card board can be formed by processing the sheet through mechanical processing techniques such as punching or cutting, and the sheet can be made of materials such as cardboard or steel plate. The surplus part of the card board 1 can be used for pasting stickers, such as the surplus part below the right leg corresponding to the card board 1 in FIGS. 2-4. The sticker can display basic information such as patterns, style numbers, sizes, quantities, recipients, and order numbers, making production and shipping easier.

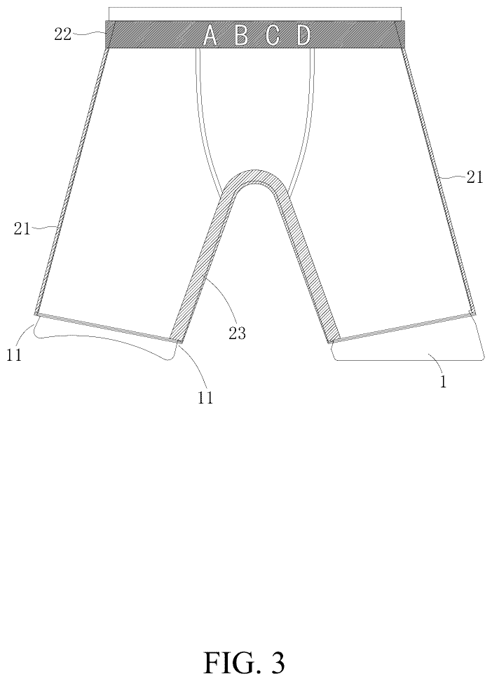

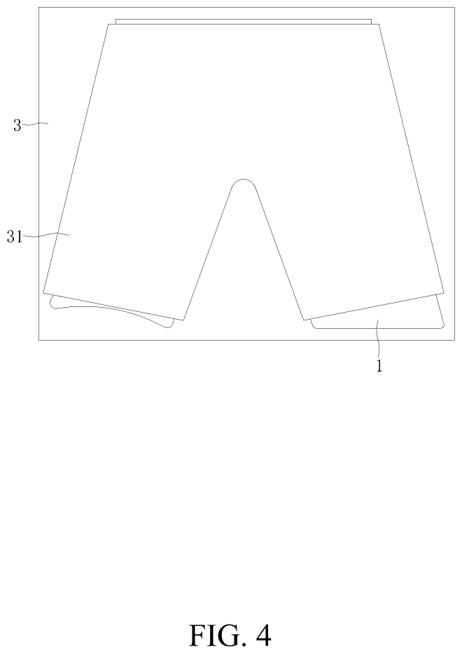

In the prepared stamp paper, as shown in FIGS. 3 and 4, the area of the pattern 31 in the stamp paper 3 is larger than the area of the cardboard 1, so that the pattern 31 in the stamp paper 3 can cover the entire surface of the finished garment when laid flat (i.e., the front or back of the main body), specifically, the pattern 31 in the stamp paper 3 is 2 cm larger on all sides than the cardboard 1. The processing process of the printed paper can be to print the pattern onto the transfer paper with heat transfer ink through heat transfer.

Process of flattening finished garment 2 involves, for example, as shown in the accompanying FIG. 3, inserting the cardboard 1 into the finished garment 2. Since the size of the cardboard 1 is larger than the size of the finished garment 2 when flattened, the cardboard 1 can expand the finished garment 2 after being inserted, forming a panel structure with the finished garment and the cardboard 1, where the front and back of the panel structure correspond to the front and back of the main body of the finished garment 2. The cardboard 1 is used to assist in shaping the finished garment 2 and can flatten the finished garment 2 to the maximum extent, keeping the front and back of the entire body of the finished garment 2 flat during the heat transfer process, thereby avoiding wrinkles in the fabric and resulting in white spots in the pattern after heat transfer.

Furthermore, referring to FIG. 2, in the portion where the card is embedded in the clothing, hook slots 11 are set at both ends of the two side edges. After the card board 1 is inserted into the finished garment 2, the hook groove 11 hooks onto the inner side of the finished garment 2. As shown in FIG. 3, the card board 1 described herein can fix the width direction (i.e., left and right direction) of the finished garment 2, while the structure of the hook groove 11 can hook the height direction (i.e., up and down direction) of the finished garment 2, preventing the finished garment 2 from shrinking in the height direction and not being able to fully spread out and flatten.

Process of transferring patterns is carried out on a transfer printing equipment, preferably a flat heat transfer machine. The pressure set on the transfer equipment is 0.6-0.8 MP, the temperature set around is 210-220° C., the middle temperature set is 205-215° C., and the pressing time is 65-75 seconds. Specifically, the pressure is set at 0.70 MP, the temperature around is 214° C., the middle temperature is 210° C., and the pressing time is 70 seconds. Before carrying out the process of transferring patterns, the panel structure can be placed in the transfer equipment for the process of preheating with compressed air.

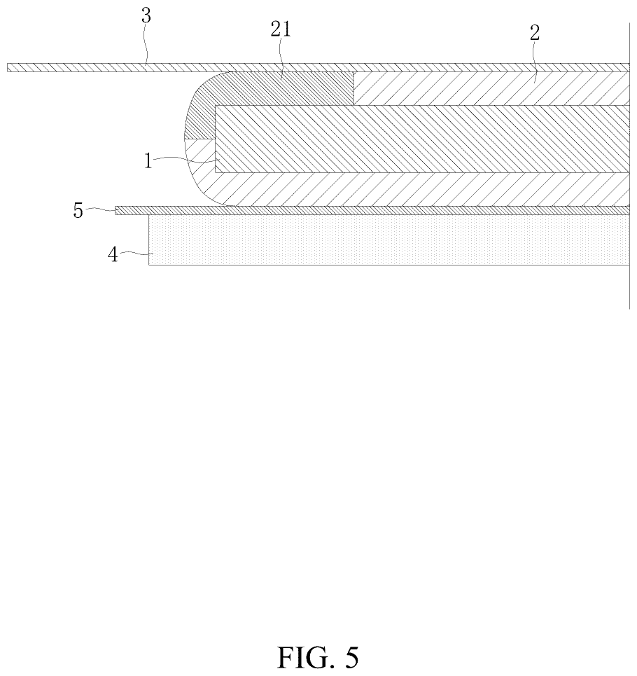

Specific process of air preheating is that after the panel structure is placed on the workbench of the transfer equipment, and before the transfer paper is covered on the panel structure, the transfer equipment is pressed at a set temperature for 8-12 seconds, completing the preheating of the transfer equipment and the shaping of the finished garment in the panel structure; then the process of transferring the pattern is carried out. The process of preheating with compressed air can ensure the uniform distribution of temperature in the middle area of the transfer equipment, avoiding color differences on the surface of the finished garment caused by uneven temperature during heat transfer printing; At the same time, this preheating process can also shape the finished garment under high pressure, making it less prone to stretching and deformation, thus preventing the transfer pattern from unevenly covering the surface of the finished garment due to stretching and deformation during heat transfer printing. Referring to FIG. 5, during the air preheating process, both the front and back of the panel structure are covered with a layer of protective paper 5. After the air preheating is completed, the paper above the panel structure is removed, and then the process of heat transfer printing the pattern is carried out. Covering the finished garment 2 with a layer of protective paper 5 can prevent it from getting dirty during the air compression preheating process of the transfer equipment.

Process of heat transfer printing pattern is as shown in FIG. 5, the front and back of the panel structure are facing up and covered with the transfer paper 3, then pressed separately, so that the pattern on the transfer paper 3 is transferred to the front and back of the finished garment 2, completing the garment printing. Taking the front side of the panel structure as an example, after placing the panel structure with the front side up on the workbench of the transfer printing equipment, flip the covering area 21 upwards and wedge it against the edge of the card board 1; then overlay the pattern of the transfer paper 3 on the surface of the panel structure, align the pattern of the transfer paper 3 with the surface of the panel structure, check up, down, left, and right to ensure that all parts of the surface of the panel structure are covered by the pattern of the transfer paper 3, so that the pattern after heat transfer will not be skewed; then the transfer equipment presses the transfer paper 3 and the finished garment 2, completing the transfer of the pattern on the front of the garment 2. In this method, when printing on the front or back of the finished garment, the covering area 21 is always flipped upwards to avoid overlapping patterns between the front and back of the garment 2 at the joint position.

From the above process, it can be seen that in the printing process of the present invention, finished garments can be mass-produced, and then relevant patterns can be printed on the finished garments according to demand, thus forming a style of clothing. This process can achieve colorful and flawless printing on finished garments in a ready-to-wear state, meeting the demand for customized, fast delivery to end consumers. It helps improve the efficiency of customization and reduce the threshold for personalized customization.

Referring to FIG. 5, a heat-resistant silicone pad 4 with a thickness of about 1 cm can be laid on the workbench of the preferred transfer device. The protective paper 5 is placed on the silicone pad 4, and the panel structure is placed on the protective paper 5 located on the silicone pad 4. The structure of the silicone pad 4 described herein ensures that when the pressure plate of the transfer device is pressed down, the gap between the stitching and the main body fabric in the finished garment 2 can be flattened.

It is worth mentioning that before transferring the pattern, if the finished garment has areas that do not require printing, those areas should be covered with high-temperature tape. For example, as shown in the attached FIG. 3, when the elastic band surface of the waist part 22 of the finished garment 2 is equipped with a LOGO, high-temperature tape can be pre-pasted at this position to cover the LOGO and the elastic band, avoiding the pattern on the transfer paper 3 from being transferred to the waist position during heat transfer, thus serving as a protective cover to protect the LOGO and the elastic band.

In conclusion, in the process of this invention, the cost can be minimized because the finished garments are mass-produced in the factory process. Profits are allocated to individual entrepreneurs, internet celebrities, or authorized parties of intellectual properties, enabling them to invest more funds into the research and development of new IPs, forming a positive cycle of drive. At the same time, the process of the present invention does not require a large amount of stock for styles with a particular pattern. It only needs to transfer the pattern to the pre-produced finished garments, which can greatly reduce the inventory of clothing for a single style. For individual entrepreneurs, internet celebrities, and authorized parties of intellectual properties, they can cover all patterns and IPs with lower inventory, thus reducing capital occupation, lowering financing costs, and operational risks.

The above is only a specific embodiment of the present invention. The design concept of the present invention is not limited to this. Any non-substantial modifications to the present invention based on this concept shall be deemed to infringe the scope of protection of the present invention.

1. Printing process for clothing, characterized in that the printing process comprises:
Prepare finished garments, where the finished garments are sewn with black mesh thread at the seam joints to form an overlay area;
Prepare a cardboard, the shape of the cardboard is consistent with the finished garment, and the size of the cardboard is larger than the size of the finished garment after flattening; On both sides of the cardboard embedded in the garment, hook grooves are set; After the cardboard is embedded in the finished garment, the hook grooves hook onto the inner side of the finished garment;
Prepare printing paper, the area of the pattern on the stamp paper is larger than the area of the cardboard;
Support the finished garment, embed the cardboard into the finished garment, so that the cardboard can support the finished garment, forming a panel structure with the finished garment and the cardboard, the panel structure having a front and back for the transfer pattern, and flipping the edge of the covering area to the side with the transfer pattern;
Transfer the pattern by placing the front and back of the panel structure facing up and covering it with transfer paper, then pressing them separately; This will transfer the pattern on the front and back of the finished garment respectively, completing the garment printing;
When heat transferring the pattern, the pressure set on the transfer equipment is 0.6-0.8 MP, the set temperature around the edges is 210-220° C., the set temperature in the middle is 205-215° C., and the pressing time is 65-75 seconds; The transfer equipment used is a flat heat transfer machine;
Printing process includes preheating by air compression; After the panel structure is placed on the workbench of the transfer printing equipment, and before the printing paper is covered on the panel structure, the transfer printing equipment presses at a set temperature for 8-12 seconds; Then, the printing paper is covered on the surface of the panel structure where the pattern is to be printed, aligning the pattern on the printing paper with the surface of the panel structure, and then pressing the printing paper and the panel structure to complete the heat transfer of the pattern.

2. Printing process for clothing as claimed in claim 1, characterized in that: when the finished garment is pants, black fabric pieces are used in the crotch area of the finished garment.

3. Printing process for clothing as claimed in claim 1, characterized in that: before transferring the pattern by heat transfer, if the finished garment has positions that do not require printing, these positions are covered with high-temperature tape.

4. Printing process for clothing as claimed in claim 1, characterized in that: the transfer device is a flat heat transfer machine, when transferring the heat transfer pattern, the pressure set by the transfer device is 0.6 to 0.8 MP, the temperature set around is 210 to 220° C., the temperature set in the middle is 205 to 215° C., and the pressing time is 65 to 75 seconds.

5. Printing process for clothing as claimed in claim 1, characterized in that: when transferring the pattern, a layer of silicone pad is laid on the workbench of the transfer printing equipment, and the panel structure is placed on the silicone pad.

6. Printing process for clothing as claimed in claim 1, characterized in that: during the air pressure preheating, a protective paper is covered on both the front and back of the panel structure; after the air pressure preheating is completed, the protective paper above the panel structure is removed, and the printing paper is covered on the panel structure.

7. Printing process for clothing as claimed in claim 1, characterized in that the processing process of the finished garment is to cut the fabric into pieces, then send the pieces to the sewing workshop, and after passing the inspection, iron the garment to obtain the finished garment.
